(19) United States
(12) Patent Application Publication
(10) Pub. No.: US 2024/0393755 A1
(43) Pub. Date: Nov. 28, 2024

(54) METHOD FOR PROVIDING DATA FOR OPERATING A BUILDING

(71) Applicant: Robert Bosch GmbH, Stuttgart (DE)

(72) Inventors: Alwar Srinivas Mandyam Bhoolokam, Ottobrunn (DE); Andreas Mauer, Utting Am Ammersee (DE)

(21) Appl. No.: 18/697,404

(22) PCT Filed: Sep. 19, 2022
(86) PCT No.: PCT/EP2022/075955

§ 371 Date: Mar. 29, 2024

(30) Foreign Application Priority Data
Oct. 1, 2021 (DE) 10 2021 211 110.6

(51) Int. Cl. G05B 17/02

(52) U.S. Cl. CPC G05B 17/02; G05B 2219/2642

(57) ABSTRACT

The invention relates to a method for providing data (156, 158) for operating a building (100) comprising systems (112.1, 112.3, 122.1, 122.2, 122.3, 136.1, 136.2, 136.3) which are installed in the building and act as data sources and each of which is assigned one of a plurality of domains (110, 120, 130) of the building, wherein a digital twin (160) is provided, by means of which at least one part of the building (100) is imaged as a model, wherein the plurality of domains (110, 120, 130) are combined in the digital twin (160), and data (154) detected by the systems is obtained, supplied to the digital twin (60), and processed. Data (156, 158) processed by the digital twin (160) is provided in order to operate the building (100).

### BACKGROUND

The present invention relates to a method for providing data for operating a building as well as a computing unit and a computer program for carrying it out.

DE 10 2018 205 872 A1 describes a method for generating a digital twin (DT) of a physical object.

### SUMMARY

According to the invention, a method for providing data for operating a building as well as a computing unit and a computer program for carrying it out are proposed with the features of the independent patent claims. Advantageous embodiments are the subject matter of the dependent claims and the following description.

The invention deals with the application of digital twins in building technology or in connection with buildings, e.g., for monitoring them or for detecting anomalies or faults. Preferably, the digital twin is a digital representation of an object in the real world of the building. The digital twin enables data to be exchanged between the object in the real world and digital systems. In particular, digital twins can be used to represent a past and present state of physical objects of buildings, to predict the future state of physical objects of buildings and to simulate or test future processes and changes. A building and the existing or installed devices and/or systems (such as ventilation, lighting, air conditioning system, fire alarm system) can be represented or imaged using computer models (so-called “Building Information Modeling”, BIM) or the aforementioned digital twins. Such models or digital twins of the building can be used for the construction phase, for example, to optimize planning or detect collisions. These models can, for example, involve the geometric modeling of the systems and their location within the building.

Digital twins can also be created for the systems themselves and used to model their behavior during operation. The system behavior during operation can be modeled on the basis of current sensor values from the system or in the system's environment.

The interaction of the technical system with the building infrastructure can also be simulated to improve and illustrate the planning. For example, elevator operation can be simulated in the building in order to intelligently control the flow of people in emergency situations. For example, the aforementioned BIM model and digital twins can be merged to control operations. Real-time data from sensors from different systems, such as building automation or access systems, can be used for control purposes.

By using digital twins in combination with the (concrete) building infrastructure, it is possible, for example, to make predictions about system behavior, save costs and carbon dioxide or identify safety risks or hazards. All in all, the use of digital twins enables a better understanding of the interactions between the specific system and the current building structure.

Such predictions can be generated, for example, by intelligent algorithms (artificial neural networks, decision trees, etc.) that learn the behavior of the systems (systems, building infrastructure) within a domain (e.g., fire or fire alarm system, building automation, access or building access control, light or light control, etc.) and detect (anomalous) behavior (deviating from regular or normal behavior) on the basis of what has been learned (so-called “insights”).

It is possible to exchange data between the digital twins of different or plurality of domains (i.e., one digital twin per domain) in order to obtain more or further information. As has been shown, however, this is often not sufficient for the efficient and safe operation of a building.

What has been learned about the behavior of the building or systems can, for example, be transferred to comparable systems and other, different buildings with, for example, different installation conditions; this usually requires a standardization of the influencing variables in the models. This standardization concerns the parameters (e.g., geometry, fluid mechanical parameters, electrical parameters, etc.) of the system itself and parameters of the building infrastructure (topologies, relation in the building context).

Here, too, it has been shown that the use of insights gained from sensor data from one domain is often not sufficient for efficient and safe operation (e.g., with control) of a building with a total of different domains.

Against this background, the present invention proposes an operation of a building with systems installed therein acting as a data source, each of which is assigned to one of the plurality of domains of the building, and in particular the provision of data for such an operation or for use in the operation. In particular, one or a plurality of such systems are assigned to each domain. Systems acting as a data source are to be understood in particular as sensors and/or control systems, e.g., card readers that output information (data) about whether or which access card has been read, or motion sensors that detect movement by people and switch on a light based on this. Sensors or other systems can be both wired and wireless. Wireless networks that detects the presence of mobile communication devices and output information (data) based on this are also conceivable.

A domain is a specific group or infrastructure that belongs together and to which a number of such systems acting as a data source belong, possibly also other components or controllers or other devices that form a kind of unit or interact with each other. Examples of domains are a fire alarm system, an air conditioning and/or ventilation system, a building and/or room access control system, a lighting control system, a video surveillance system, an air quality analysis system, a room utilization and workplace booking system, a fire prevention and/or extinguishing system, and a voice alarm and/or audio system. The systems and possibly other components of a domain typically have a certain topology or arrangement that is based on the topology of the building or part of it. For example, motion detectors of a lighting control system are arranged according to the rooms or corridors in the building.

In a building and/or room access control system, there are, for example, the aforementioned card readers, e.g., at building entrances and/or in individual, possibly special rooms, which allow or deny people access to the building or room. This can also include, for example, a time recording system where people check in on arrival and check out on departure. In addition to the readers, which have information about which or how many people are present, such a domain also includes, for example, barriers that physically allow or block access.

In a lighting control system, for example, motion sensors or motion detectors can be considered as sensors that switch on an associated light or lamp when motion is detected. However, this can also be used to provide information on whether a person is in the vicinity.

A digital twin is now provided, e.g., by operating corresponding software with a computer model of the building on a computer unit or a computer system, with which at least part of the building is imaged as a model. The plurality of domains are combined in the digital twin, i.e., the digital twin does not represent just one domain and there is not a plurality of digital twins, each of which images a single domain, but the plurality of domains, i.e., at least two domains, are combined in one digital twin. The data detected by the systems (acting as data sources) is obtained, fed into the digital twin or the corresponding model and processed (therein). Data processed by the digital twin is then provided for operating the building.

This allows the building to be operated particularly effectively and efficiently. The operation of the building, in which the data obtained can be used, can in particular comprise at least one of the following actions: monitoring of the building, wherein preferably an optical and/or acoustic alarm is emitted if a hazardous situation is detected; control and/or regulation of functions in the building, including in individual domains, for example setting the air conditioning system; detection of malfunctions, in particular in one of the domains, wherein preferably an optical and/or acoustic alarm is emitted if a malfunction is detected; detection of anomalies in relation to regular or normal operation (e.g., of a domain), wherein preferably an optical and/or acoustic alarm is emitted if an anomaly is detected; a determination of causes of malfunctions; an indication of (possibly pending or exceptionally necessary) maintenance and preferably the output of an optical and/or acoustic display.

The fact that data or information from different domains can be combined or linked with each other by using them in a digital twin (i.e., a model of the building) is particularly important here. This makes it possible, for example, to check and/or check the plausibility of data from systems in different domains. The data can also be used between the domains, i.e., the data generated by a system in one domain can be used in the other domain so that, for example, individual systems (sensors) can be saved.

By combining data from the plurality of domains, the behavior of systems in buildings can be imaged much more precisely and therefore a more accurate statement can be made about the behavior of a system, for example. Anomalies and malfunctions in installations or systems, for example, can be detected at an early stage and faults and, in particular, the causes of faults can be identified. This enables precise control of a system or premature replacement of components to prevent damage (reduction of maintenance costs). A system can be operated with higher performance because, for example, algorithms for analyzing system behavior can be made more precise, which leads to a reduction in operating costs.

A control system in such a building is (more) robust against faults. Special cases of operation can, for example, be regulated by the system itself and do not require an experienced technician to optimize the system for corresponding special cases (reduction of manual workload). The use of cross-domain sensor technology (i.e., the use or exchange of data from sensors between domains) can save hardware in the building. System operation becomes more transparent for specialist personnel and the training and optimization of processes is easier (at least if necessary).

What has been learned can also be easily transferred to other systems and/or other buildings, as the ontologies of the digital twin are standardized or can at least be standardized (transferability and thus cost advantages and increased flexibility for the application). Ontologies are usually linguistic and formally organized representations of a set of terms and the relationships between them in a specific subject area; they are used to exchange knowledge or information in digitalized and formal form between application programs and services.

The more data or sensor values are available, the more accurately the actual operating conditions can be imaged in the digital twin. As a rule, it is expedient for the data to be correctly correlated. In the digital twin, it is possible to combine the topologies (structure) of individual domains using the relationships (ontologies) within the domain and within the building. By processing the data from the plurality of domains in a (single) digital twin, a realistic image of reality (the real housing) is created. For example, by covering a plurality of domains, the digital twin can be used to recognize a special feature (“insight”) during operation that cannot be detected within a single domain.

For example, the motion sensor of the lighting control system in the building detects movement and thus the presence of a person. At the same time, however, the counter on the access control system indicates, for example, that there are no more people in the house. A technician who activates the alarm system using the data in the access control system would therefore most likely trigger a false alarm. However, if the access control system were to obtain the data from the lighting control system at the same time, the number of people inside the building could be checked for plausibility in this system, i.e., it could be recognized, for example, that there may have been an error in the access control count, e.g., because a person has checked out but not left the building. This is made possible by the proposed procedure.

Another example is the combination of temperature sensors from building automation (e.g., in the air conditioning and/or ventilation system) and the fire detection system or fire alarm system. Based on the building topology and the topology of the fire alarm system and air conditioning and/or ventilation system, the digital twin has the information that there are, for example, three sensors in a particular room. These can be the temperature sensor of the fire detector, the temperature sensor in the control panel of the building automation system and the air quality sensor (with integrated temperature measurement, for example) on the ceiling of the room. If one of the sensors shows temperature values that deviate too much (from the other sensors), the system can detect a malfunction of this sensor and inform the technician. If the system only included the building automation sensors, a targeted two-out-of-three evaluation would not be possible.

In addition, codified expert knowledge and physical models can be used as the basis for learning algorithms. In other words, in particular, a behavior of at least one of the domains in the digital twin can be trained using data of a previous behavior of the domain and/or a behavior of a comparable domain, preferably using methods based on artificial intelligence, i.e., training of, for example, an artificial neural network can take place.

For example, expert knowledge can comprise the flow characteristics of a cooling system. Experts recognize, e.g., from experience, when certain values change unfavorably and thus indicate damage in the system (flow rate and consumption values). Expert knowledge comprises an understanding of the interaction of multiple values and goes beyond the mere consideration of individual values.

Self-learning algorithms usually require a training phase in which the system (with the digital twin) learns the behavior of the system based on historical data. The historical data must be classified so that the algorithm can, for example, distinguish malfunction from normal behavior (“supervised learning” for neural networks). However, this training phase is time-consuming and requires the know-how (knowledge) of experts on site to classify the data. The learning algorithms can already be equipped with relationships (e.g., links between different domains or their data) that have been set up by experts. Based on these relationships, the data can be classified and evaluated independently. In addition, a plausibility check is possible using physical impact models (which may be contained in the digital twin). The time-consuming learning process with the support of experts is therefore no longer necessary (saving time and effort)

The system behavior and, in particular, the malfunction of the system can be described using semantic models or data models. In the context of data modeling, a semantic data model is an abstract, formal description and representation of a section of the “perceived world” in a specific context (e.g., a project), in this case the building with its systems.

The knowledge of domain experts can be codified by these models and boundaries can be set by parameters. For example, a leakage in a volume flow controller can be described by the deviation in the combination of flow rate and damper blade position. Physical laws can also be imaged. For example, a leakage is detected on the basis of mass conservation if the supplied air mass in a pipe does not correspond to the discharged air mass. Due to the topology of the system, the digital twin then detects which side is the inlet side and which is the outlet side of the pipe and compares the data points of the volume flows and can thus detect a leakage.

The models also allow the system behavior to be predicted on the basis of a time series and can indicate when the system behavior deviates from the forecast. In addition, expert knowledge and physical models can form the basis for reinforcement learning. An algorithm calculates the optimum system behavior within states defined by expert knowledge and physical models. The utility function can be the system consumption. By narrowing down the states using expert models, the utility function converges more quickly.

A computing unit according to the invention, e.g., a central control system in a building, is set up, in particular in terms of programming, to carry out a method according to the invention.

The implementation of a method according to the invention in the form of a computer program or computer program product comprising program code for carrying out all method steps is advantageous as well, because the associated costs are very low, in particular if an executing control device is also used for other tasks and is therefore already available. Lastly, a machine-readable storage medium is provided, on which a computer program as described above is stored. Suitable storage media or data carriers for providing the computer program are in particular magnetic, optical and electrical memories, such as hard drives, flash memories, EEPROMs, DVDs, etc. Downloading a program via computer networks (Internet, intranet, etc.) is possible, too. Such a download can be wired or cabled or wireless (e.g., via a WLAN, a 3G, 4G, 5G or 6G connection, etc.).

### BRIEF DESCRIPTION OF THE DRAWINGS

Additional advantages and embodiments of the invention result from the description and the enclosed drawings.

The invention is illustrated schematically in the drawing on the basis of an exemplary embodiment and is described in the following with reference to said drawing.

### BRIEF DESCRIPTION OF THE DRAWINGS

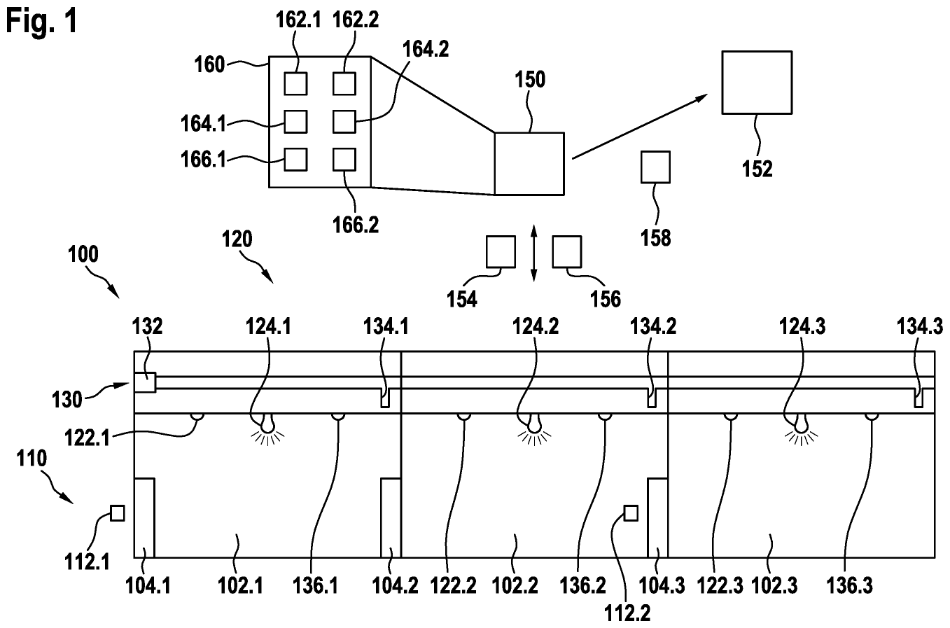

FIG. 1 schematically shows a building with domains to illustrate a method according to the invention in a preferred embodiment.

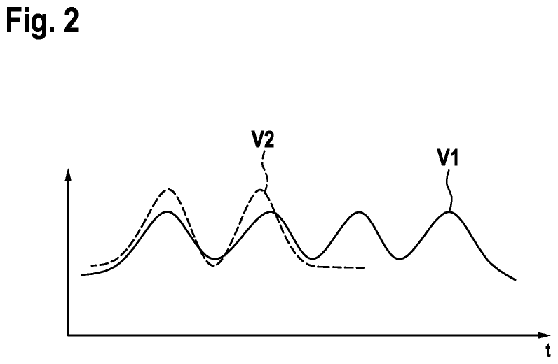

FIG. 2 schematically shows a behavior of a domain of a building to explain a method according to the invention in a further preferred embodiment.

### DETAILED DESCRIPTION

FIG. 1 schematically shows a building 100 with domains for explaining a method according to the invention in a preferred embodiment. As an example, the building 100 has three rooms 102.1, 102.2 and 102.3, with a door 104.1, 104.2 or 104.3 being provided for each room. As an example, door 104.1 serves as the building entrance door.

Exemplary card readers 112.1 and 112.3 are provided at the doors 104.1 and 104.3, which are assigned to an “access control” domain 110. In this way, it is possible, for example, to register whether a person enters the building or a room, or whether a person is (still) in a room.

A motion detector 122.1, 122.2 or 122.3 and a lamp 124.1, 124.2 or 124.3 are provided in each room, which are assigned to a “light control” domain 120. In this way, a person in a room can be detected by a motion detector and the corresponding lamp can then be switched on.

Furthermore, a ventilation pipe 134.1.1, 134.2 or 134.3 and a temperature sensor 136.1, 136.2 or 136.3 are provided in each room, the ventilation pipes being connected to an air conditioning compressor 132; these pipes, the temperature sensors and the air conditioning compressor are assigned to an “air conditioning system” domain 130.

Furthermore, a computing unit 150 is provided on which a digital twin 160 is provided. This digital twin 160 images at least part of the building as a model, combining a plurality of domains. Exemplary semantic models 162.1, 164.1 and 166.1 are shown, which comprise an ontological description of the three domains access control 110, lighting control 120 and air conditioning system 140. In addition, topological models 162.2, 164.2 and 166.2 are shown, which comprise a topological description of the three domains access control 110, lighting control 120 and air conditioning system 140, i.e., describe, for example, the arrangement (positions, etc.) of the individual systems of the domains concerned within the building.

Using these models, the (complex) behavior of the systems (the domains) can be transferred to different building structures without explicitly adapting the behavior to the special features of the building structure. A (very) simple rule is, for example, that lights and air conditioning system are switched off as soon as no one is present in the restricted area. This rule can then be applied to all types of building structures.

During operation, data 154 from the systems of the individual domains acting as data sources is now obtained and fed to the digital twin 160. These systems comprise, for example, the 112.1 and 112.3 card readers and the 122.1, 122.2 and 122.3 motion detectors. This data 154 is processed in the digital twin and processed data 156, 158 is then provided that can be used to operate the building 100.

For example, the air conditioning system 130 can be operated based on which room people are in, but also based on the current temperature in the room in question. This can be determined using the card readers and motion detectors and, if applicable, the temperature sensors or the information provided by them. In particular, the information obtained from the card readers and the motion detectors can also be checked against each other for plausibility.

The building can also be monitored on a monitor or display 152; for example, it can be shown whether there are people in the building or in which rooms and whether the air conditioning system is working. Here too, for example, the information obtained from the card readers and the motion detectors can be checked against each other for plausibility.

FIG. 2 schematically illustrates the behavior of a domain of a building to explain a method according to the invention in a further preferred embodiment. The behavior is shown here in the form of a curve of measured values from a domain, e.g., the temperatures in a room of the building. V₁ shows a predicted curve, e.g., based on previous measured values and/or comparable domains (e.g., a comparable room in another building). With V₂, an actual course is shown as it corresponds to the current measured values.

In principle, for example, the predicted curve can be used to control or pre-control the air conditioning system, while the actual curve can be used for control or fine-tuning. However, a deviation between the two curves can also be used to detect an anomaly in the operation of the building or a malfunction in the air conditioning system, for example. However, information from the access control system or the lighting control system can be taken into account here, for example, to check whether the anomaly is due to people unexpectedly being present or whether there is actually a malfunction.

1. A method for providing data (156, 158) for operating a building (100) comprising systems (112.1, 112.3, 122.1, 122.2, 122.3, 136.1, 136.2, 136.3) which are installed in the building and act as a data source, each system being assigned one of a plurality of domains (110, 120, 130) of the building, the method comprising:
providing a digital twin (160), by means of which at least one part of the building (100) is imaged as a model, wherein the plurality of domains (110, 120, 130) are combined in the digital twin (160),
obtaining data (154) detected by the systems, supplying the data to the digital twin (60), and processing the data via the digital twin, and
operating the building (100) by using the data (156, 158) processed by the digital twin (160).

2. The method according to claim 1, wherein operating the building (100) comprises at least one of the following actions:
monitoring the building (100),
control and/or regulation of functions in a domain (110, 120, 130),
detection of malfunctions in a domain (110, 120, 130),
detection of anomalies in relation to regular operation,
determining the causes of malfunctions, and
indications of maintenance.

3. The method according to claim 1, wherein the plurality of domains (110, 120, 130) comprise at least two of the following domains: a fire alarm system, an air conditioning and/or ventilation system, a building and/or room access control system, a lighting control system, a video surveillance system, an air quality analysis system, a room utilization and workplace booking system, a fire prevention and/or extinguishing system, and a voice alerting and/or audio system.

4. The method according to claim 1, wherein each of the plurality of domains (110, 120, 130) is assigned one or a plurality of systems acting as a data source.

5. The method according to claim 1, wherein the systems acting as data source comprise sensors and/or control systems.

6. The method according to claim 1, wherein data of a system to which one domain (110, 120, 130) is assigned, is used to check and/or plausibilize data of a system to which another domain (110, 120, 130) is assigned.

7. The method according to claim 1, wherein data of a system to which one domain (110, 120, 130) is assigned, is used for an operation of another domain (110, 120, 130).

8. The method according to claim 1, wherein a behavior of at least one of the domains in the digital twin (160) is trained using data of a previous behavior of the domain and/or a behavior of a comparable domain, preferably using artificial intelligence-based methods.

9. The method according to claim 1, wherein a behavior of at least one of the domains in the digital twin (160) is predicted based on data of a previous behavior of the domain and/or a behavior of a comparable domain using artificial intelligence-based methods.

10. A computer (150) configured to perform a method according to claim 1.

11. (canceled)

12. A non-transitory, computer-readable storage containing instructions that when executed by a computer cause the computer to operate a building (100) comprising systems (112.1, 112.3, 122.1, 122.2, 122.3, 136.1, 136.2, 136.3) which are installed in the building and act as a data source, each system being assigned one of a plurality of domains (110, 120, 130) of the building, by:
providing a digital twin (160), by means of which at least one part of the building (100) is imaged as a model, wherein the plurality of domains (110, 120, 130) are combined in the digital twin (160),
obtaining data (154) detected by the systems, supplying the data to the digital twin (60), and processing the data via the digital twin, and
operating the building (100) by using the data (156, 158) processed by the digital twin (160).
